(19) United States
(12) Patent Application Publication
(10) Pub. No.: US 2021/0165912 A1
(43) Pub. Date: Jun. 3, 2021

(54) SYSTEM AND METHOD FOR IMPROVING SECURITY OF PERSONALLY IDENTIFIABLE INFORMATION

(71) Applicant: TRUATA LIMITED, Dublin 18 (IE)

(72) Inventors: Yangcheng HUANG, Dublin 18 (IE); Nikita RAJVANSHI, Dublin 18 (IE)

(73) Assignee: TRUATA LIMITED, Dublin 18 (IE)

(21) Appl. No.: 16/702,223

(22) Filed: Dec. 3, 2019

(51) Int. Cl. G06F 21/62; G06K 9/62; G06Q 20/38

(52) U.S. Cl. CPC G06F 21/6254; G06Q 20/383; G06K 9/6218; G06K 9/6267

(57) ABSTRACT

A system and method for improving security of personally identifiable information including a history of user's economic transactions (e.g., credit card transaction, loyally card transaction, etc.), user's usage patterns of power, media and telecom stored in a data storage and retrieval system. The system and method prohibit a user from being uniquely identified by the information stored in the data storage and the retrieval system.

### BACKGROUND

Personal data is the currency of the digital economy. Estimates predict the total amount of personal data generated globally will hit 44 zettabytes by 2020, a tenfold jump from 4.4 zettabytes in 2013. Digital advertising companies make millions of dollars by mining this personal data in order to market products to consumers. However, digital thieves have been able to steal hundreds of millions of dollars' worth of personal data. In response, governments around the world have passed comprehensive laws governing the security measures required to protect personal data.

For example, the General Data Protection Regulation (GDPR) is the regulation in the European Union (EU) that imposes stringent computer security requirements on the storage and processing of “personal data” for all individuals within the EU and the European Economic Area (EEA). Article 4 of the GDPR defines “personal data” as “any information relating to an identified or identifiable natural person . . . who can be identified, directly or indirectly, in particular by reference to an identifier such as a name, an identification number, location data, an online identifier or to one or more factors specific to the physical, physiological, genetic, mental, economic, cultural or social identity of that natural person.” Further, under Article 32 of the GDPR, “the controller and the processor shall implement appropriate technical and organizational measures to ensure a level of security appropriate to the risk.” Therefore, in the EU or EEA, location data that can be used to identify an individual must be stored in a computer system that meets the stringent technical requirements under the GDPR.

Similarly, in the United States, the Health Insurance Portability and Accountability Act of 1996 (HIPAA) requires stringent technical requirements on the storage and retrieval of “individually identifiable health information.” HIPAA defines “individually identifiable health information” any information in “which there is a reasonable basis to believe the information can be used to identify the individual.” As a result, in the United States, any information that can be used to identify an individual must be stored in a computer system that meets the stringent technical requirements under HIPPA.

However, “Unique in the Crowd: The Privacy Bounds of Human Mobility” by Montjoye et al. (Montjoye, Yves-Alexandre De, et al. “Unique in the Crowd: The Privacy Bounds of Human Mobility.” Scientific Reports, vol. 3, no. 1, 2013, doi:10.1038/srep01376), which is hereby incorporated by reference, demonstrated that individuals could be accurately identified by an analysis of their data. Specifically, Montjoye’ analysis revealed that with a dataset containing hourly locations of an individual, with the spatial resolution being equal to that given by the carrier's antennas, merely four spatial-temporal points were enough to uniquely identify 95% of the individuals. Montjoye further demonstrated that by using an individual's resolution and available outside information, the uniqueness of that individual's traces could be inferred.

The ability to uniquely identify an individual based upon collected information alone was further demonstrated by “Towards Matching User Mobility Traces in Large-Scale Datasets” by Kondor, Daniel, et al. (Kondor, Daniel, et al. “Towards Matching User Mobility Traces in Large-Scale Datasets.” IEEE Transactions on Big Data, 2018, doi:10.1109/tbdata.2018.2871693.), which is hereby incorporated by reference. Kondor used two anonymized “low-density” datasets containing mobile phone usage and personal transportation information in Singapore to find out the probability of identifying individuals from combined records. The probability that a given user has records in both datasets would increase along with the size of the merged datasets, but so would the probability of false positives. The Kondor's model selected a user from one dataset and identified another user from the other dataset with a high number of matching location stamps. As the number of matching points increases, the probability of a false-positive match decreases. Based on the analysis, Kondor estimated a matchability success rate of 17 percent over a week of compiled data and about 55 percent for four weeks. That estimate increased to about 95 percent with data compiled over 11 weeks.

Montjoye and Kondor concluded that an individual can be uniquely identified by their location information alone. Since the location data can be used to uniquely identify an individual, the location data is “personal data” under GDPR and “individually identifiable health information” under HIPAA.

Application X entitled “A SYSTEM AND METHOD FOR IMPROVING SECURITY OF PERSONALLY IDENTIFIABLE INFORMATION”, which is hereby incorporated by reference, describes an approach for anonymizing user's location information as the user moves in physical space.

Application Y entitled “A SYSTEM AND METHOD FOR IMPROVING SECURITY OF PERSONALLY IDENTIFIABLE INFORMATION”, which is hereby incorporated by reference, describes an approach for anonymizing user's browsing history information as the user navigates across the websites that comprise the internet.

However, the ability to uniquely identify an individual by their tracked movements is not limited to motion in physical space. Similarly, a history of user's economic transactions (e.g., credit card transaction, loyalty card transaction, etc.) can be used to identify the individual user. In addition, a user's health transactions (e.g., visits to clinics, diagnostic test, etc.) can also be used to identify the individual user. Therefore, just like a sequence of time-stamped GPS coordinates are “personal data” under GDPR and “individually identifiable health information” under HIPAA, so are a sequence of time-stamped economic transactions and healthcare transactions of the user.

As a result, the records regarding a user's economic and health transactions must be stored in a data storage and retrieval system in such a way that it prohibits a user from being uniquely identified by the information stored in the data storage and the retrieval system. It is, therefore, technically challenging and economically costly for organizations and/or third parties to use gathered personal data in a particular way without compromising the privacy integrity of the data.

In addition to economic transactions, a user can also be identified by their usage patterns. For example, a user can be uniquely identified based upon their power usage as recorded by a smart power meter. In other instances, the user may be identified based on their consumption of media as recorded by a mobile phone or television set-top box. In an additional example, a user can be identified by the patterns in their telephone usage (e.g., when and to whom they placed a telephone call). Therefore, just like a sequence of time-stamped GPS coordinates are “personal data” under GDPR and “individually identifiable health information” under HIPAA, so are the user's usage patterns of utilities, media, and telecom.

As a result, the records regarding a user's usage patterns of power, media and telecom must be stored in a data storage and retrieval system in such a way that it prohibits a user from being uniquely identified by the information stored in the data storage and the retrieval system. It is, therefore, technically challenging and economically costly for organizations and/or third parties to use gathered personal data in a particular way without compromising the privacy integrity of the data.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a schematic representation of a system that utilizes aspects of the secure storage method for economic transactions;

FIG. 1B is a schematic representation of a system that utilizes aspects of the secure storage method for healthcare transactions;

FIG. 1C is a schematic representation of a system that utilizes aspects of the secure storage method for usage patterns of utilities;

FIG. 1D is a schematic representation of a system that utilizes aspects of the secure storage method for usage patterns for the consumption of media;

FIG. 1E is a schematic representation of a system that utilizes aspects of the secure storage method for usage patterns for telecom usage;

FIG. 1F is a schematic representation of an example anonymization server;

FIG. 2A is a graphical display of an example of “economic transaction” data;

FIG. 2B is a graphical display of an example of “healthcare transaction” data;

FIG. 2C is a graphical display of an example of “utility consumption” data;

FIG. 2D is a graphical display of an example of “media consumption” data;

FIG. 2E is a graphical display of an example of “telecom consumption” data;

FIGS. 3A and 3B are graphical representations of a prior art method of anonymizing trajectory data;

FIG. 4A is a diagram of communication between components in accordance with an embodiment;

FIG. 4B is a diagram of communication between components in accordance with an embodiment;

FIG. 4C is a diagram of communication between components in accordance with an embodiment;

FIG. 5A is a process flow diagram of an example of the secure storage method for processing batches of transactions;

FIG. 5B is a process flow diagram of an example of the secure storage method for processing incremental transactions;

FIG. 6 illustrates an example process to partition trajectories;

FIG. 7A illustrates an example of partition trajectories for an economic transaction;

FIG. 7B illustrates an example of partition trajectories for a health care transaction;

FIG. 7C illustrates an example of partition trajectories for a utility usage pattern transaction;

FIG. 7D illustrates an example of partition trajectories for a media consumption pattern transaction;

FIG. 7E illustrates an example of partition trajectories for a telecom usage pattern transaction;

FIG. 8 illustrates an example method to determine the similarity between trajectory partitions; and

FIGS. 9A and 9B illustrate an example process to generate the anonymized trajectories.

### DETAILED DESCRIPTION OF THE PREFERRED EMBODIMENTS

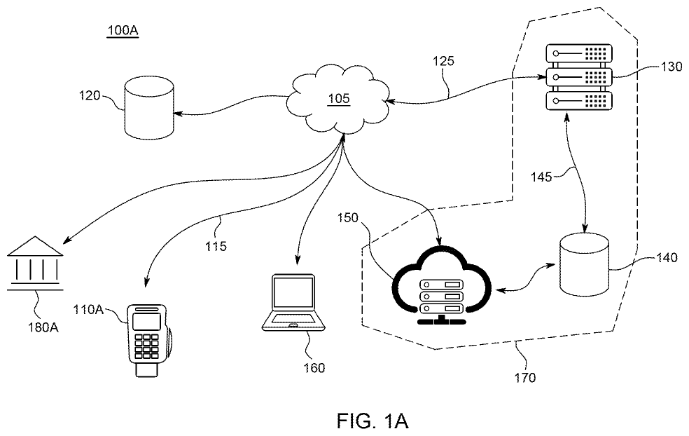

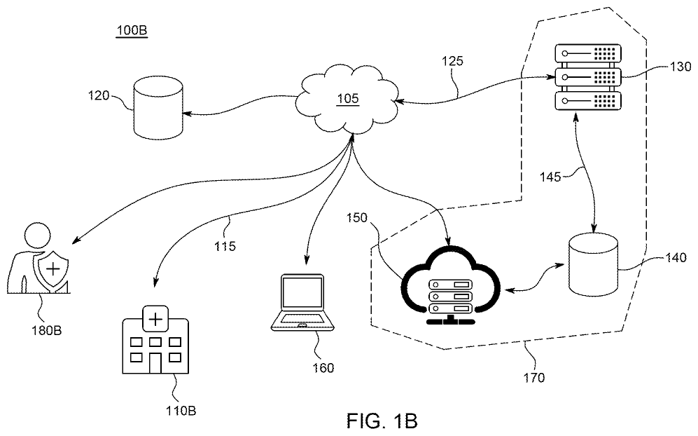

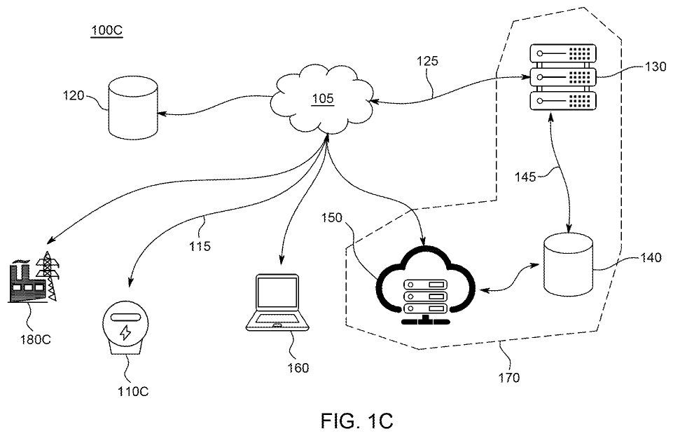

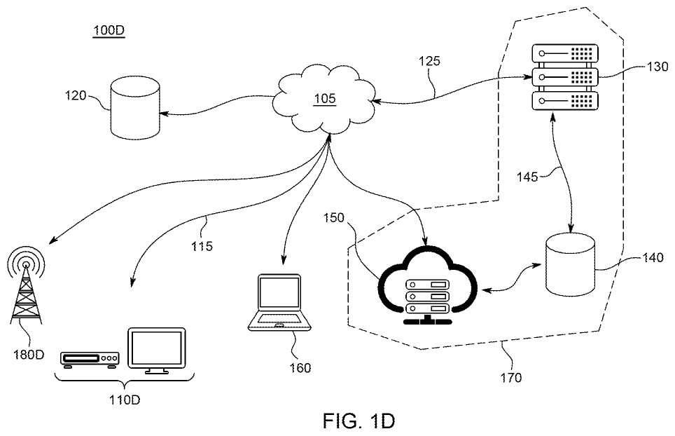

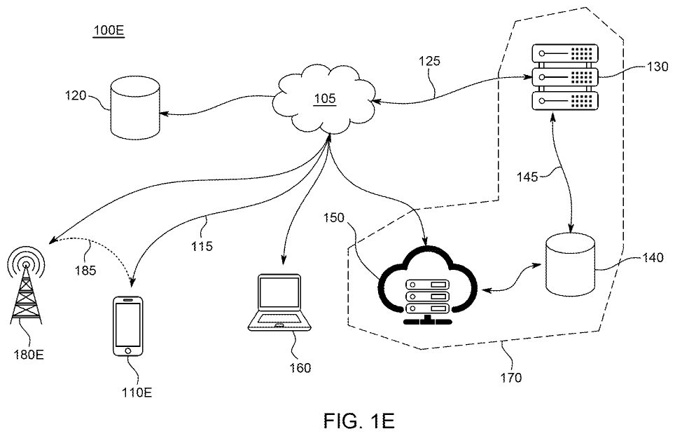

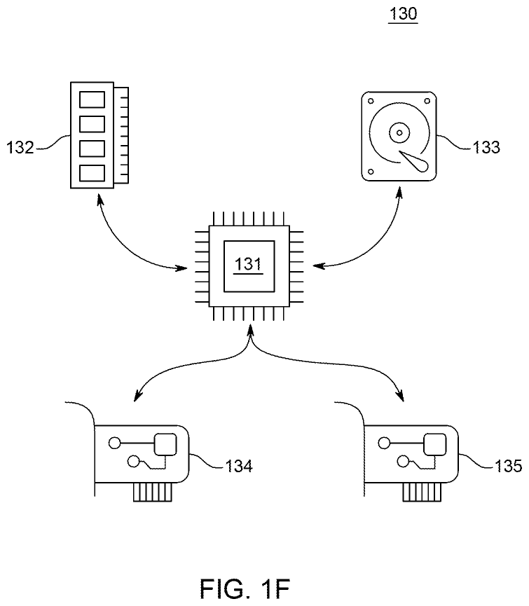

FIG. 1A is a diagram illustrating the components of the system 100A that is used to anonymize economic transactions. In system 100A, a user makes a purchase with a merchant 110A using an electronic payment. In some instances, the electronic payment may be in the form a physical card/debit card (such as issued by Mastercard®), a smart wallet (such as Google Wallet®) or a loyalty/gift card (such as the Starbucks Card®). The electronic payment is processed by a point of sale device (such as a card reader) of the merchant 110A by securely exchanging the account information of the user with a financial institution 180A. The communication between the merchant 110A and the financial instruction 180A may occur via a wired or wireless communication channel 115 using various short-range wireless communication protocols (e.g., Wi-Fi), various long-range wireless communication protocols (e.g., 3G, 4G (LTE), 5G (New Radio)) or a combination of various short-range and long-range wireless communication protocols.

In most instances, the secure exchange of the account information between the merchant 110A and the financial institution 180A is governed by the Europay, Mastercard and Visa (EMV) standards, such as EMV standard 4.3, which is hereby incorporated by reference.

In order to facilitate proper accounting and billing of the user's transactions, the financial institution 180A must store transaction details for each transaction the user makes. For example, the transaction details may include the amount of the transaction, time, date and location of the transaction. In some instances, the transaction details may also include information about the type of goods purchased or a classification of the merchant 110A.

The transaction details are stored by the financial institution 180A in the User Identifiable Database 120. The User Identifiable Database 120 stores transaction details for a plurality of users. However, a user can only access their own information that is stored in the User Identifiable Database 120. The User Identifiable Database 120 may be implemented using a structured database (e.g., SQL), a non-structured database (e.g., NoSQL) or any other database technology known in the art. In other cases, the “economic transaction” may be stored in a file system, either a local file storage or a distributed file storage such as Hadoop File System (HDFS), or a blob storage such as AWS S3 and Azure Blob.

The User Identifiable Database 120 may run on a dedicated computer server or may be operated by a public cloud computing provider (e.g., Amazon Web Services (AWS)®).

The anonymization server 130 receives data stored in the User Identifiable Database 120 via the internet 105 using wired or wireless communication channel 125. The data may be transferred using Hypertext Transfer Protocol (HTTP), File Transfer Protocol (FTP), Simple Object Access Protocol (SOAP), Representational State Transfer (REST) or any other file transfer protocol known in the art. In some instances, the transfer of data between the anonymization server 130 and the User Identifiable Database 120 may be further secured using Transport Layer Security (TLS), Secure Sockets Layer (SSL), Hypertext Transfer Protocol Secure (HTTPS) or other security techniques known in the art.

The anonymized database 140 stores the secure anonymized data received by anonymization server 130 executing the anonymization and secure storage method 500A or 500B (to be described hereinafter). In some instances, the secure anonymized data is transferred from the anonymization server 130 to the anonymization database 140 using a wired or wireless communication channel 125. In other instances, the anonymization database 140 is integral with the anonymization server 130.

The anonymized database 140 stores the secure anonymized data so that data from a plurality of users may be made available to a third party 160 without the third party 160 being able to associate the secure anonymized data with the original individual. The secure anonymized data includes location and timestamp information. However, utilizing the system and method which will be described hereinafter, the secure anonymized data cannot be traced back to an individual user. The anonymized database 140 may be implemented using a structured database (e.g., SQL), a non-structured database (e.g., NOSQL) or any other database technology known in the art. The anonymized database 140 may run on a dedicated computer server or may be operated by a public cloud computing provider (e.g., Amazon Web Services (AWS)®).

An access server 150 allows the Third Party 160 to access the anonymized database 140. In some instances, the access server 150 requires the Third Party 160 to be authenticated through a user name and password and/or additional means such as two-factor authentication. Communication between the access server 150 and the Third Party 160 may be implemented using any communication protocol known in the art (e.g., HTTP or HTTPS). The authentication may be performed using Lightweight Directory Access Protocol (LDAP) or any other authentication protocol known in the art. In some instances, the access server 150 may run on a dedicated computer server or may be operated by a public cloud computing provider (e.g., Amazon Web Services (AWS)®).

Based upon the authentication, the access server 150 may permit the Third Party 160 to retrieve a subset of data stored in the anonymized database 140. The Third Party 160 may retrieve data from the anonymized database 140 using Structured Query Language (e.g., SQL) or similar techniques known in the art. The Third Party 160 may access the access server 150 using a standard internet browser (e.g., Google Chrome®) or through a dedicated application that is executed by a device of the Third Party 160.

In one configuration, the anonymization server 130, the anonymized database 140 and the access server 150 may be combined to form an Anonymization System 170.

FIG. 1B is a diagram illustrating the components of the system 100B that is used to anonymize healthcare transactions. In system 100B, the user receiving a medical treatment (i.e., physical exam, diagnostic test, prescription drug, etc.) from a healthcare provider 110B. In some cases, the healthcare provider 110B may be a doctor's office, clinic, pharmacy or hospital. Prior to receiving the treatment from the healthcare provider 110B, the user is required to provide payment information such as Health Insurance card (US) or National Health Service Number (UK). This information is then transmitted along with the services rendered to the user to healthcare payment entity 180B over wired or wireless communication channel 115.

In order to facilitate proper accounting and payment to the health services provider 110B, the healthcare payment entity 180B must store transaction details for each healthcare transaction. The healthcare payment entity 180B may be a health insurance company, a state health services department or the like. The transaction details are stored by the healthcare payment entity 180B in the User Identifiable Database 120. The transaction details may include the type of treatment, time, date and location of that the healthcare provided by the treatment provider 110B. The Identifiable Database 120 may be of the same type as described with regard to the system 100A that is used to anonymize economic transactions.

The Anonymization System 170, retrieves the data stored in the User Identifiable Database 120, executes the anonymization and secure storage method 500A or 500B (to be described hereinafter) and stores the anonymized data in the anonymized database 140. The Anonymization System 170 may be of the same type as described with regard to the system 100A that is used to anonymize economic transactions.

FIG. 1C is a diagram illustrating the components of the system 100C that is used to anonymize usage patterns of utilities (e.g., electric energy, water, natural gas etc.) In system 100C, smart utility meter 110C records consumption of the utilities by the user and communicates the information to the utility supplier 180C for monitoring and billing over wired or wireless communication channel 115. In many instances, the smart utility meter 110C communicates with the utility supplier 180C using ANSI C12.18, IEC 62056, ISO/IEC 14908 or Open Smart Grid Protocol (OSGP) which are hereby incorporated by reference.

In order to facilitate proper accounting and billing of the user's utility consumption, the utility supplier 180C must store transaction details for each smart meter 110C that is associated with a particular user. These transaction details may include the amount, time, date and type of utility consumed. In addition, the transaction details may also include information on the geographic location where the smart meter 110C is installed. The transaction details are stored by the utility supplier 180C in the User Identifiable Database 120. The Identifiable Database 120 may be of the same type as described with regard to the system 100A that is used to anonymize economic transactions.

The Anonymization System 170, retrieves the data stored in the User Identifiable Database 120, executes the anonymization and secure storage method 500A or 500B (to be described hereinafter) and stores the anonymized data in the anonymized database 140. The Anonymization System 170 may be of the same type as described with regard to the system 100A that is used to anonymize economic transactions.

FIG. 1D is a diagram illustrating the components of the system 100D that is used to anonymize usage patterns of media. The media may be of the form of television stations watched, television program recorded by a Digital Video Recorder (DVR), On-Demand video streamed or the playback of videos on optical media (e.g., Blue Ray, DVD, etc.). In some instances, the system 100D includes a step-top box/television 110D such as a Comcast X1 TV Box® or TiVo Bolt Vox®. In other instances, the system 100D includes a step-top box/television 110D such as an Apple TV® or Roku Streaming Stick S. In other instances, the system 100D includes a step-top box/television 110D such as Roku TV® or Sony SmartTV®. In some instances, the step-top box/television 110D implements tacking software such as provided by Samba TV®.

In system 100D, step-top box/television 110D records consumption of the media by the user and communicates the information to the content provider or to the manufacturer of the step-top box/television for monitoring and billing over wired or wireless communication channel 115. In many instances, the step-top box/television 110D communicates with the content provider 180D using protocols in line with the Advanced Television Systems Committee (ATSC) 3.0 standard which is hereby incorporated by reference.

In order to facilitate proper accounting, make content recommendations and target advertising at the user, the content provider 180D may store transaction details on the user's consumption of media. In some instances, the content provider is a cable company (such as Comcast®), a streaming service (such as Sling TV®) or an on-demand video provider (such as Netflix®). The transaction details may include the time, date, channel and duration of viewing of the media content. Other transactions details that may be recorded include the manufacturer, model and serial number of the set-top box/television, subscription details and network details.

The content provider 180D stores the transactions details in the User Identifiable Database 120. The Identifiable Database 120 may be of the same type as described with regard to the system 100A that is used to anonymize economic transactions.

The Anonymization System 170, retrieves the data stored in the User Identifiable Database 120, executes the anonymization and secure storage method 500A or 500B (to be described hereinafter) and stores the anonymized data in the anonymized database 140. The Anonymization System 170 may be of the same type as described with regard to the system 100A that is used to anonymize economic transactions.

FIG. 1E is a diagram illustrating the components of the system 100E that is used to anonymize telecommunication usage. In system 100E, a user makes a phone call using a phone 110E. In some instances, the phone 110E is a wired phone and in other instances the phone 110E is a wireless phone. The phone 110E is able to access the Publicly Switched Telephone Network (PSTN) via the telecommunication provider 180E. In some instances, the phone 110E communicates with telecommunication provider 180E via wired or wireless communication channel 105. In other instances, the phone 110E via wireless communication channel 185. Communication over communication channel 185 may be governed by any of 3rd Generation Partnership Project (3GPP) protocols.

In order to facilitate proper accounting and billing of the user's phone calls, the telecom provider 180E must store transaction details for each transaction the user makes. For example, the transaction details may include the number dialed, time, date, duration and location of the phone call. In some instances, the transaction details may also include information about the type of phone number called (e.g., restaurant, spouse, parent, friend, etc.).

The telecom provider 180E stores the transactions details in the User Identifiable Database 120. The Identifiable Database 120 may be of the same type as described with regard to the system 100A that is used to anonymize economic transactions.

The Anonymization System 170, retrieves the data stored in the User Identifiable Database 120, executes the anonymization and secure storage method 500A or 500B (to be described hereinafter) and stores the anonymized data in the anonymized database 140. The Anonymization System 170 may be of the same type as described with regard to the system 100A that is used to anonymize economic transactions.

FIG. 1F is a block diagram of an example device anonymization server 130 in which one or more aspects of the present disclosure are implemented. The anonymization server 130 may be, for example, a computer (such as a server, desktop, or laptop computer), or a network appliance. The device anonymization server 130 includes a processor 131, a memory 132, a storage device 133, one or more first network interfaces 134, and one or more second network interfaces 135. It is understood that the device 130 optionally includes additional components not shown in FIG. 1F.

The processor 131 includes one or more of: a central processing unit (CPU), a graphics processing unit (GPU), a CPU and GPU located on the same die, or one or more processor cores, wherein each processor core is a CPU or a GPU. The memory 132 is located on the same die as the processor 131 or separately from the processor 131. The memory 132 includes a volatile or non-volatile memory, for example, random access memory (RAM), dynamic RAM, or a cache.

The storage device 133 includes a fixed or removable storage, for example, a hard disk drive, a solid state drive, an optical disk, or a flash drive. The storage device 133 stores instructions enable the processor 131 to perform the secure storage methods described here within.

The one or more first network interfaces 134 are communicatively coupled to the internet 105 via communication channel 125 shown in FIGS. 1A-1E. The one or more second network interfaces 135 are communicatively coupled to the anonymization database 140 via communication channel 145.

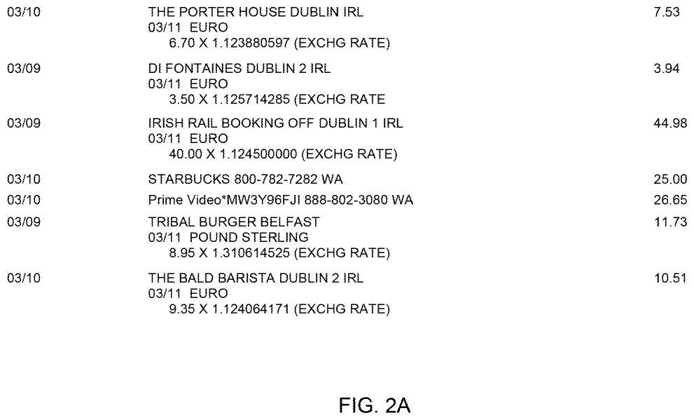

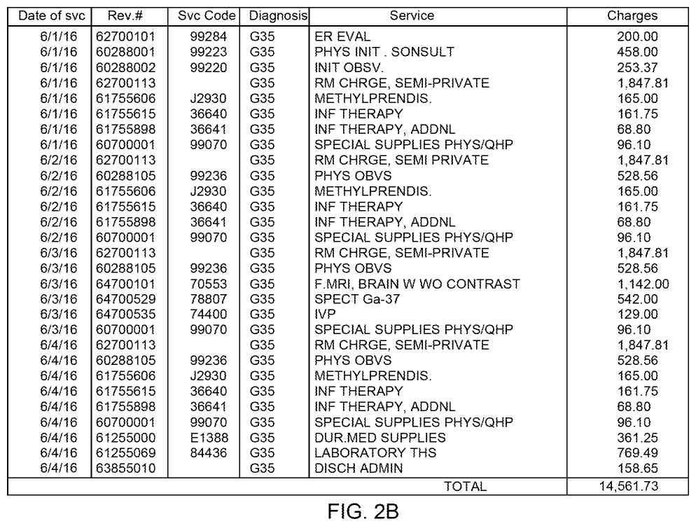

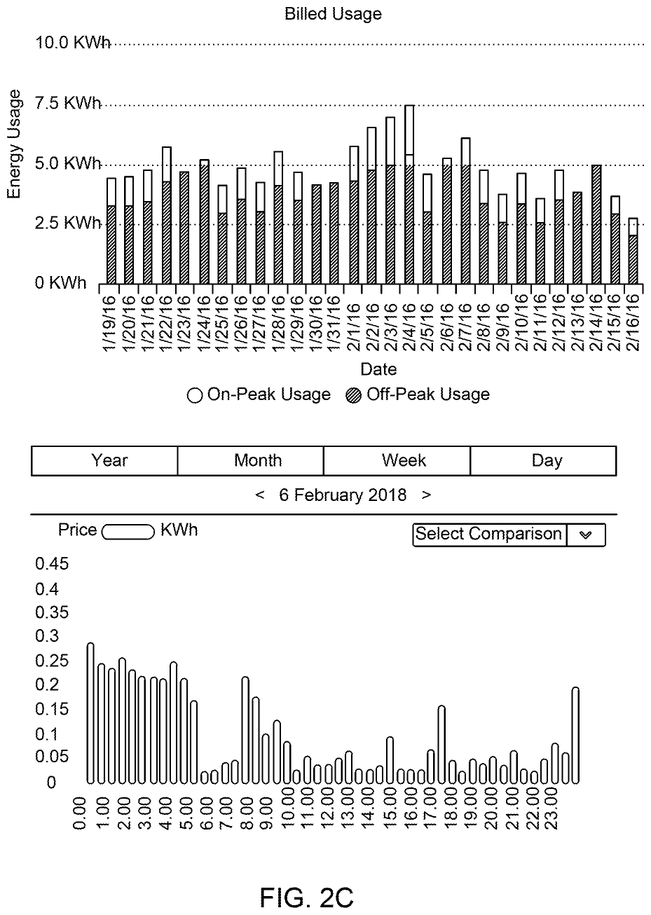

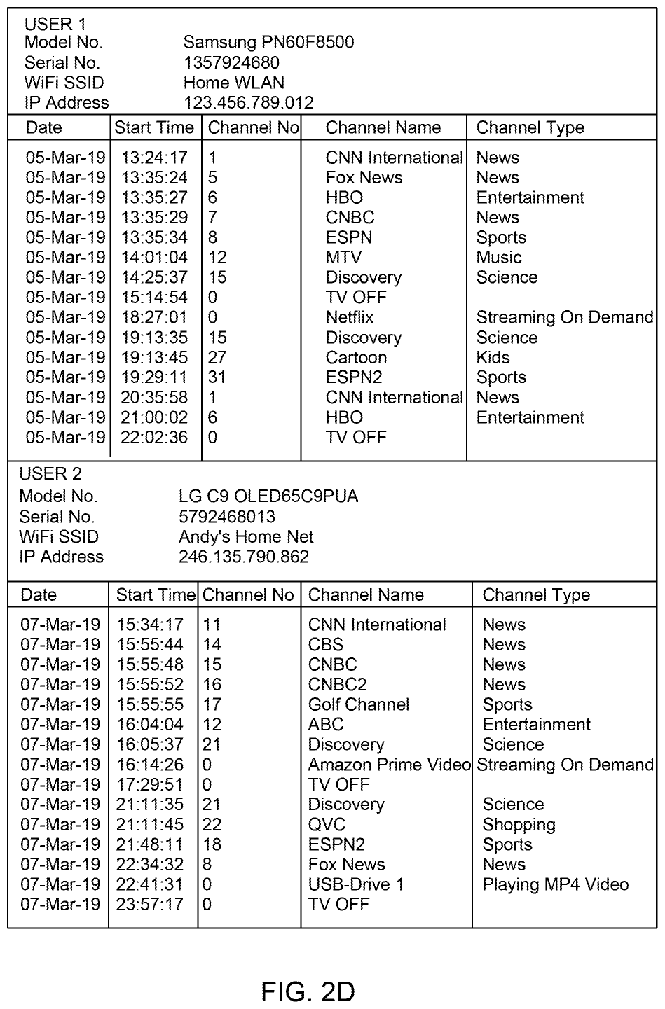

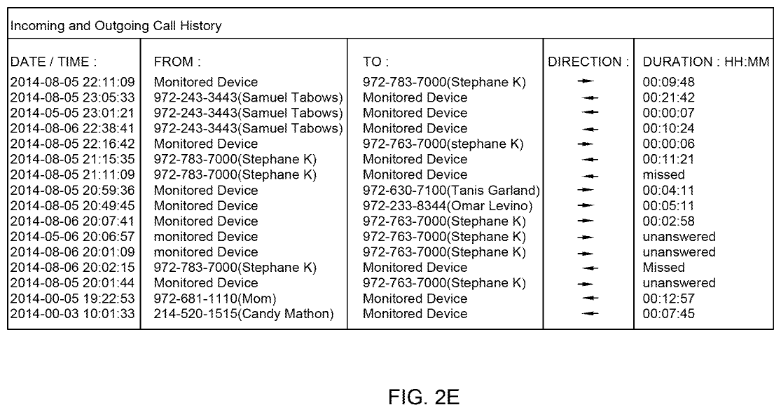

FIG. 2A illustrates an example of transaction details for an economic transaction as shown on an example credit card statement. For example. FIG. 2A illustrates example purchase transactions and a list of data types that may be collected per transaction by a particular merchant 110A or service provider. The transactions may be carried out either in Brick and Mortar store, or online stores. Different participants (merchants, banks, card providers etc.) may collect different data sets for the same transaction and card holder. Examples of the information that may be included in the data sets is shown in Table 1

TABLE 1
Card Number
Transaction Date, Time
Merchant name
Merchant ID
Merchant location
Merchant Category Code
Amount, Currency
Transaction type
Card present (with signature, or PIN)
Card on file
Card not present (with 2nd factor authentication, e.g webshop)

The listed data types are usually shared across different participants. Some attributes of the datasets may be pseudo anonymized (such as card number). However, the sequence of the transactions is untouched in existing solutions.

FIG. 2B illustrates an example of transaction details for a health care transaction as shown on a hospital billing statement. For example. FIG. 2B illustrates examples of the types of medical treatments provided on particular dates. Attributes such as service codes and diagnosis code provide rich information related to the nature of the treatments, especially combined with service description and charges.

FIG. 2C illustrates an example pattern of utility consumption as shown on an example utility bill. For example. FIG. 2C illustrates an example of daily peak and off-peak electricity usage. Aggregated usage data, including the absolute values of daily peak usage vs. off-peak, and the variations across dates, may disclose rich information related to the size of the households and the origin of the households (holidays pattern) and may be used to infer the in-house activities. The hourly fine-grained usage data then clearly shows the detailed activities of the households.

FIG. 2D illustrates an example pattern of media consumption. For example. FIG. 2D illustrates the channel name, classification of the type of channel, time and date for television channels that were watched by a first user and a second user respectively. FIG. 2D also illustrates additional information such as the make, model and serial number of the set top box that may be collected by the system. In addition, as illustrated by FIG. 2D, in some instances, the IP address of the set top box is recorded. The IP address can be used to determine the geographic location of the user.

Although FIG. 2D illustrates an example of television channel watching, analogous information can be collected on the watching habits of a user who engages with a streaming media provider (e.g. Netflix®) or an Over The Top (OTT) media service (e.g. Sky to Go®). In this case, the information would include the particular source of the streaming content, the name of the content streamed, and a classification of the streamed content. FIG. 2E illustrates an example pattern of telecom usage as shown on an example mobile phone bill. For example. FIG. 2E illustrates numbers dialed and times when the phone calls were made.

In traditional data privacy models, value ordering is not significant. Accordingly, records are represented as unordered sets of items. For instance, if an attacker knows that someone checked in first at the location c and then at e, they could uniquely associate this individual with the record t1. On the other hand, if T is a set-valued dataset, three records, namely t1, t2, and t4, would have the items c and e. Thus, the individual's identity is hidden among the three records. Consequently, for any set of n items in a trajectory, there are n! possible quasi-identifiers.

However, transaction trajectory records are different from the structure of other data records. For example, a transaction trajectory record is made of a sequence of location points, where each point is labeled with a timestamp. Ordering between data points is the differential factor that leads to the high uniqueness of transaction trajectories. Further, the length of each trajectory doesn't have to be equal. This difference makes preventing identity disclosure in trajectory data publishing more challenging, as the number of potential quasi-identifiers is drastically increased.

As a result of the unique nature of the transaction trajectory records, an individual user may be uniquely identified. Therefore, transaction trajectory records must be processed and stored such that an original individual cannot be identified in order meet to the stringent requirements under GDPR and HIPPA.

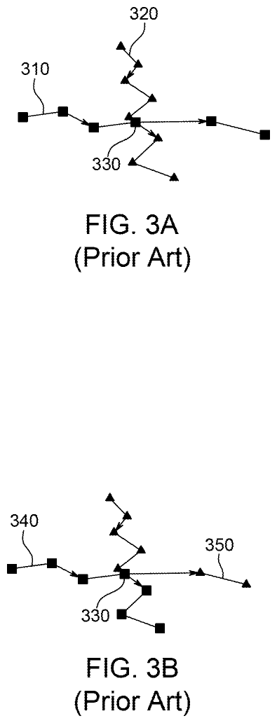

Existing solutions to the transaction trajectory records problem, such as illustrated in FIG. 3A and FIG. 3B, randomly swap parts of trajectories when two trajectories intersected. For example, FIG. 3A shows a first trajectory 310 (depicted with boxes) and a second trajectory 320 (depicted with triangles) that intersect at a point 330. The existing exchanging methods generate a third trajectory 340 (depicted with boxes) and a fourth trajectory 350 (depicted with triangles) as shown in FIG. 3B. The main drawback of existing trajectory exchanging methods is that some of the utilities of the exchanged trajectories are lost. For example, when exchanging trajectories between random users that have their paths crossed, the nature of the movements is lost, and location-based analytics is invalidated. Accordingly, it is desirable for a system to retain the utility of the original information without the information being able to be traced back to the original individual.

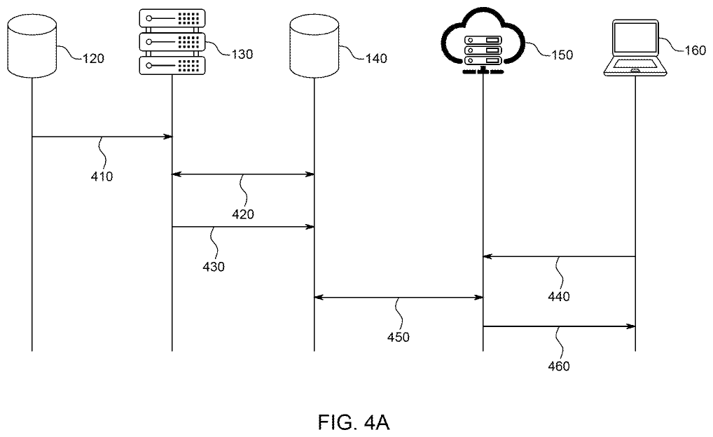

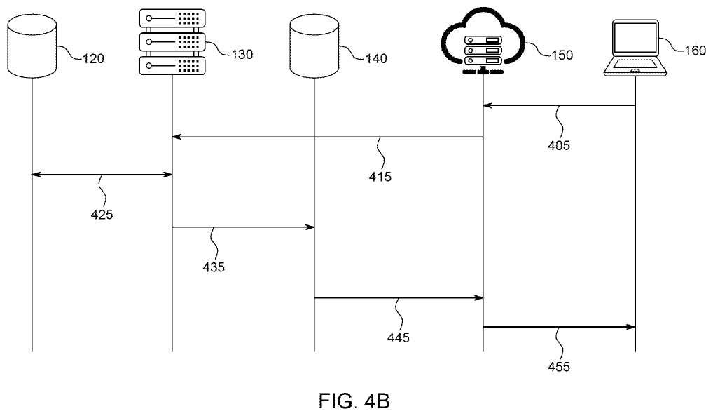

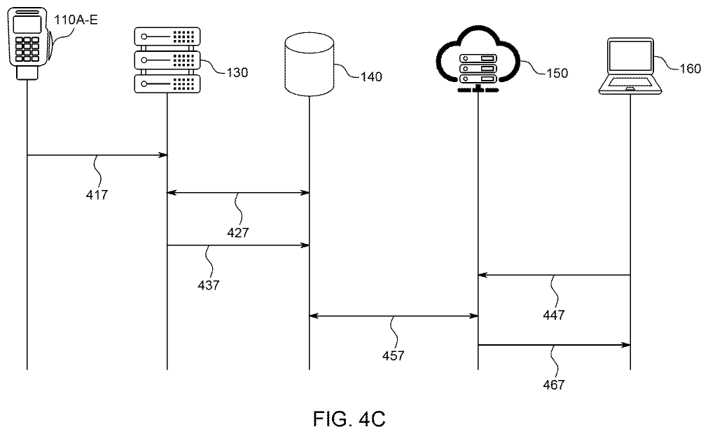

FIG. 4A is a diagram representing communication between components in accordance with an embodiment. In step 410 the transaction details are transmitted from the User Identifiable Database 120 to the anonymization server 130. The data that is transmitted from the User Identifiable Data 120 to the anonymization server 130 contains personally identifiable information of the individual users. In some instances, the data is transmitted every time a new record is added to the User Identifiable Database 120. In other instances, the data is periodically transmitted at a specified interval. In other instances, the data is transmitted in response to a request for the anonymization server 130. The data may be transmitted in step 410 using any technique known in the art and may utilize bulk data transfer techniques (e.g., Hadoop Bulk load) and may utilize additional encryption techniques.

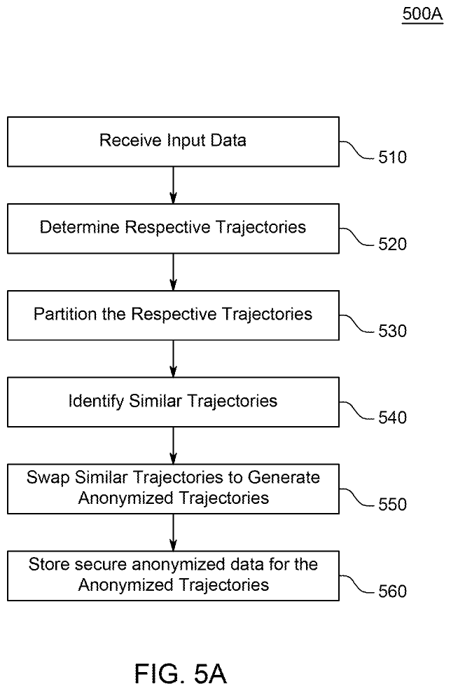

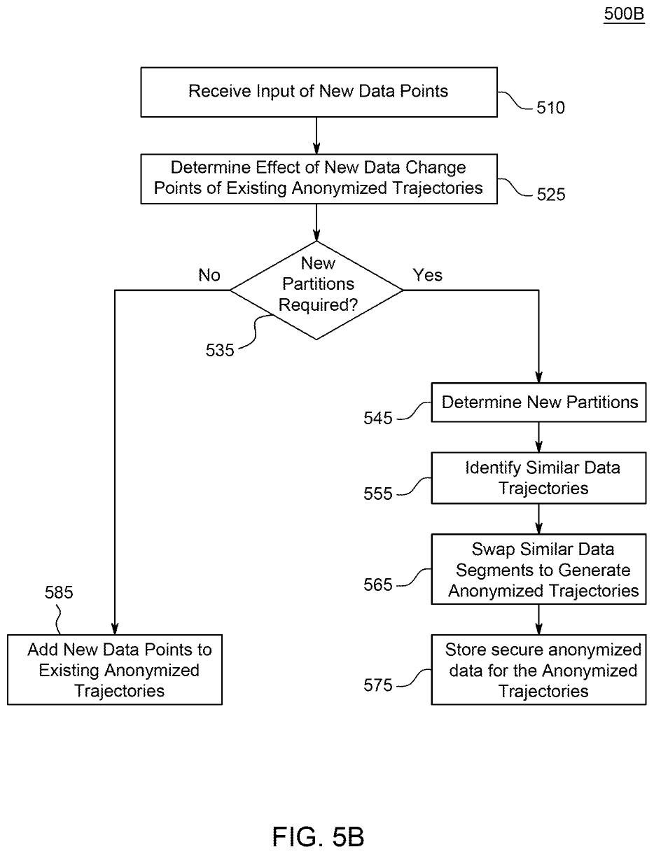

In some instances, in step 420 the anonymization server 130, retrieves secure anonymized data that has been previously stored in the anonymized database 140. The additional data retrieved in step 420 may be combined with the data received in step 410 and used the input data for the secure storage method 500A or 500B. In other instances, step 420 is omitted, and anonymization server 130 performs the anonymization and secure storage method 500A or 500B (as shown in FIGS. 5A and 5B) using only the data received in step 410 as the input data.

In step 430, the secure anonymized data generated by anonymization server 130 is transmitted to the anonymized database 140. The data may be transmitted in step 430 using any technique known in the art and may utilize bulk data transfer techniques (e.g., Hadoop Bulk load).

The Third Party 160 retrieves the secure anonymized data from the anonymized database 140 by requesting the data from the server 150 in step 440. In many cases, this request includes an authentication of the Third Part 160. If the server 150 authenticates the Third Party 160, in step 450, the server 150 retrieves the secure anonymized data from the anonymized database 140. Then in step 460, the server 150 relays the secure anonymized data to the Third Party 160.

FIG. 4B is a diagram representing communication between components in accordance with an embodiment. In step 405, the Third Party 160 requests secure anonymized data from the anonymized database 140. The request may be submitted using a web form or Application Programming Interface (API) that is provided by the server 150. For example, the Third Party 160 may request secure anonymized data for 25-40 year old women living in a certain region who has purchased an iPhone in the past 30 days.

In response, the server 150 determines that secure anonymized data has not previously been stored in the anonymized database 140 that matches the criteria included in the request. The server 150 then requests (step 415) that the anonymization server 130 generate the requested secure anonymized data. Then in step 425, the anonymization server 130 retrieves, if required, the non-anonymized transaction details required to generate the secure anonymized data from the User Identifiable Database 120. The data may be transmitted in step 425 using any technique known in the art and may utilize bulk data transfer techniques (e.g., Hadoop Bulk load).

In step 435, the secure anonymized data generated by anonymization server 130 is transmitted to the anonymized database 140. The data may be transmitted in step 435 using any technique known in the art and may utilize bulk data transfer techniques (e.g., Hadoop Bulk load). Then in step 445, the server 150 retrieves the secure anonymized data from the anonymized database 140. Then in step 455, the server 150 relays the secure anonymized data to the Third Party 160.

FIG. 4C is a diagram of communication between components in accordance with an embodiment. In step 417 transaction information is transmitted from the merchant 110A, the healthcare provider 110B, smart utility meter 110C, set-top box/television 110D or the phone 110E to the anonymization server 130 for the user's personally identifiable information to be anonymized. The data may be transmitted in step 417 transferred using Hypertext Transfer Protocol (HTTP), File Transfer Protocol (FTP), Simple Object Access Protocol (SOAP), Representational State Transfer (REST) or any other file transfer protocol known in the art.

In step 427 the anonymization server 130, retrieves secure anonymized data that has been previously stored in the anonymized database 140. The additional data retrieved in step 427 may be combined with the data received in step 410 and used the input data for the anonymization and secure storage method 500A or 500B.

In step 437, the secure anonymized data generated by anonymization server 130 is transmitted to the anonymized database 140. The data may be transmitted in step 430 using any technique known in the art and may utilize bulk data transfer techniques (e.g., Hadoop Bulk load).

The Third Party 160 retrieves the secure anonymized data from the anonymized database 140 by requesting the data for the server 150 in step 447. If the server authenticates the Third Party 160, in step 457, the server 150 retrieves the secure anonymized data from the anonymized database 140. Then in step 467, the server 150 relays the secure anonymized data to the Third Party 160.

FIG. 5A is a flow diagram of the anonymization and secure storage method 500A for processing batches of transactions. The term “batches” refers to two or more transactions of a user that are received by the Anonymization System 170 together. For example, a batch of economic transactions may include all of a user's credit card transactions for a month. Similarly, a batch of healthcare transactions may include all of the health care services received by the user in a year. Likewise, a batch of utility usage patterns may include the electricity usage for a particular season and media consumption patterns may include television shows watched in a given week.

In step 510, batches of transaction details are received from the User Identifiable Database 120. Respective transaction trajectories are then determined for each of the plurality of user included in the data received in step 520.

For example, a transaction trajectory for an economic transaction may consist of $4 dollar coffee purchased at a particular time from a particular Starbucks location followed by a $25 transit card purchased from a particular vending machine and finally an $8 dollar sandwich purchased from a particular Subway location.

Similarly, a transaction trajectory for a health care transaction may consist of a physical examination performed at a walk-in clinic, followed by an x-ray performed at an imaging center and an exam at orthopedist any of these transactions may be on the same day or different days.

In the case of a utility consumption patterns, a transaction trajectory may consist of a spike in electricity usage at 6:30 AM, followed by a drop at 7:30 AM and a spike at 6:30 PM, followed by a drop at 11:00 PM.

Likewise, a transaction trajectory for media consumption pattern that can be derived for User 1 depicted in FIG. 2D includes watching MTV from for 14:01 to 14:25, Discovery from 14:25 to 15:14 and turning the TV off at 15:14. This trajectory may suggest that User 1 is a housewife with school age children.

Further, in the case of a telecom consumption pattern, a transaction trajectory may consist of a daily phone call at 6:15 PM to a spouse to indicate they have left work.

Then in step 530, the respective transaction trajectories identified in step 520 are partitioned. Similar transaction trajectories are then identified based on the partitions in step 540. In step 550, the similar transaction trajectories identified in step 540 are exchanged. Then in step 560, secure anonymized data for the anonymized transaction trajectories generated in step 540 are stored in the anonymized database 140.

FIG. 5B is a flow diagram of the anonymization and secure storage method 500B for processing transactions incrementally. In the case of incremental transactions, the transactions details are received by the by the Anonymization System 170 individually. For example, transactions details may be individually sent to the Anonymization System 170 after a credit is used in an economic transaction or a set-top box reports that a user changed a television channel.

In step 515, new transaction details are received from the User Identifiable Database 120 incrementally. Then in step 525, the effect is determined of the new transaction details received in step 515 has upon the Existing Anonymized Trajectories stored in step 560. In step 535, the method determines whether new partitions are required.

If new partitions of the existing trajectories are required based on the new transaction details received, in step 545 new partitions of the respective transaction trajectories are then determined by applying process 530 on the new data points received in step 515. Then in step 555, similar data trajectories are identified by applying process 540 on the new partitions determined in step 545. The similar trajectories identified in step 555 are then exchanged in step 565. Then in step 575, secure anonymized data for the anonymized transaction trajectories generated in step 565 are stored in the anonymized database 140.

If in step 535 determines that new partitions are not required, in step 585 the new data points received in step 515 are added to one or more of the existing anonymized transaction trajectories stored in the anonymized database 140.

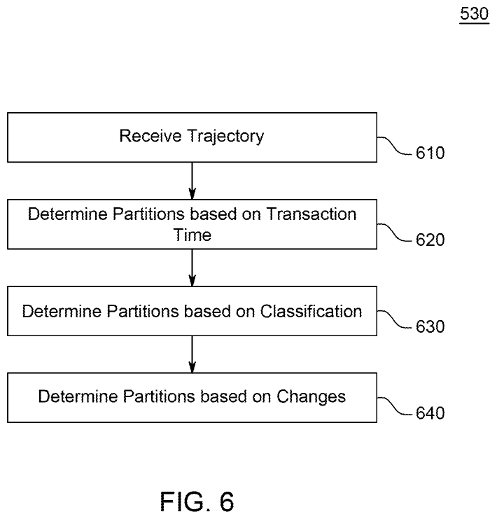

FIG. 6 illustrates the process 530 of partitioning the transaction trajectories. Process 530 finds a set of partition points where the behaviors of a trajectory change rapidly. The type of behavior that indicates a rapid change varies by the type of transaction being anonymized (e.g., economic transaction, healthcare transaction, utility usage patterns, media consumption patterns and telecom consumption patterns). One example is TV usage. The nature of the channels (and the viewing timestamps) may reveal the identity of the audience. Combined with the sequence of the consumption across different channels, the TV usage data may be used to infer the household's activities and preferences, even without detailed TV program information.

For example, in the case of economic transactions, these changes may include a change in time, amount, location or merchant classification (e.g., “Coffee Shop”, “Sporting Goods”, “Travel”, etc.). In the case of healthcare transactions, these changes may include a change in time, location or service type (e.g., “Emergency”, “Orthopedist”, “Clinic”, etc.). For utility consumption patterns, these changes may include spikes or sudden drops in utility consumption. Likewise, for media consumption patterns, these changes may include a change in time, duration, or media classification (e.g., “News”, “Sports”, “Streaming On Demand”, etc.). Similarly, for telecom usage, these changes may include a change in time, duration, location or call classification (e.g., “Spouse”, “Work”, “Restaurant”, etc.).

In step 610, a transaction trajectory TRᵢ is received. An example of a transaction trajectory. TRᵢ is a sequence of multi-dimensional points denoted by TRᵢ=p1 p2 p3 . . . pj . . . pi (1<i<n), where, pⱼ (1<j<i) is a d-dimensional point. For example, p1 may correspond to a first medical examination, p2 to a medical treatment, p3 to purchase of prescription drugs, etc.

The length i of a trajectory can be different from those of other trajectories. For instance, trajectory pc1 pc2 . . . pck (1<=c1<c2< . . . <ck<i) be a sub-trajectory of TRi. A trajectory partition is a line partition pi pj (i<j), where pi and pj are the points chosen from the same trajectory.

In step 620, the trajectory is divided into partitions based on the time the transactions that comprise the respective trajectory were made. For example, the trajectories may be partitioned by grouping trajectories for the morning, afternoon and evening. In another example, trajectories may be partitioned as being related to different medical disciplines such as orthopedic, dental or cardiological.

In step 630, the trajectory is further partitioned by classifying the type of the transactions.

For example, in the case of economic transactions, the merchant 110A that performed each of transactions may be classified as “Sporting Goods”, “Transportation”, “Bars/Restaurants” or “Entertainment”. Similarly, in the case of healthcare transactions, the health care provider 110B that performed each of transactions may be classified as “General Practice”, “Specialist”, “Pharmacy” or “Hospital”.

In the case of utility usage patterns, the transactions may be classified as “home” or “away.” For media consumption patterns, the transactions may be classified as “Sports”, “News”, “Sitcom” or “Reality”. The transactions may be classified as “Work”, “Family”, or “Merchant” in the case where the transaction is related to telecom usage patterns.

In step 640, partitioning points are determined based on the classifications made in step 620 and step 630.

For instance, in the case of an economic transaction, a first purchase from a coffee shop to a second purchase at an electronics store would indicate a partitioning point.

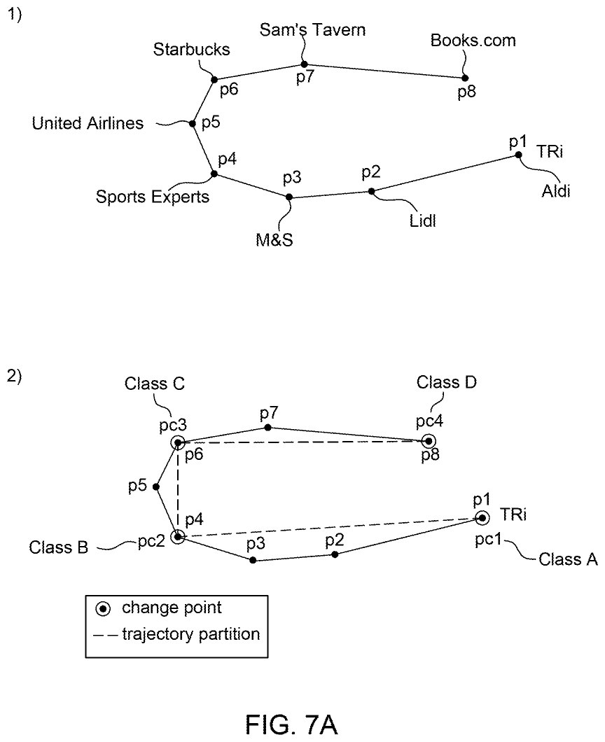

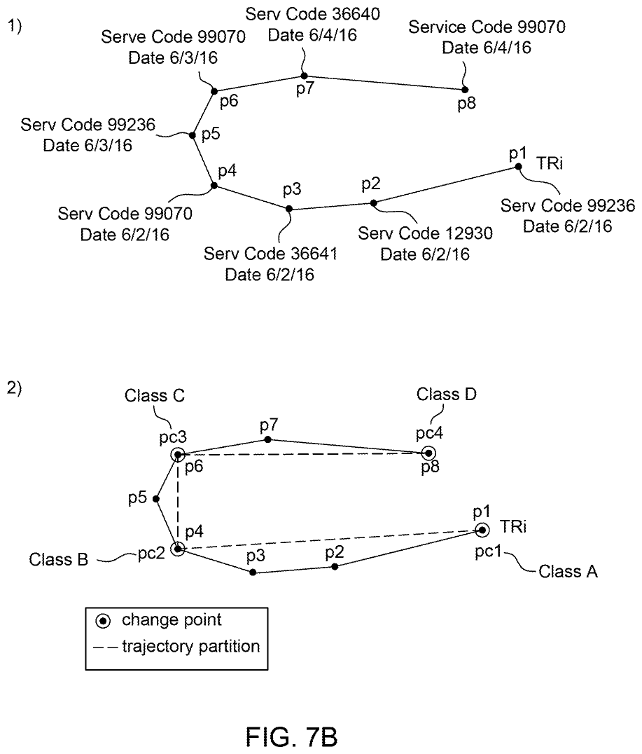

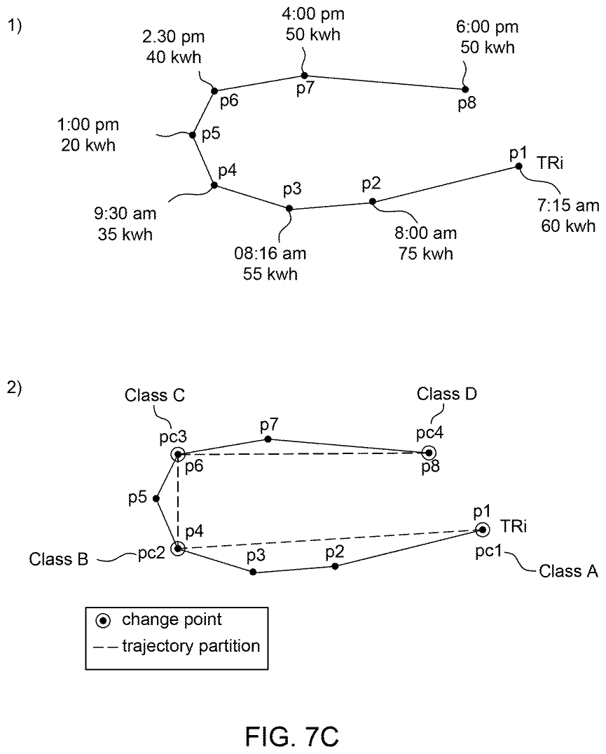

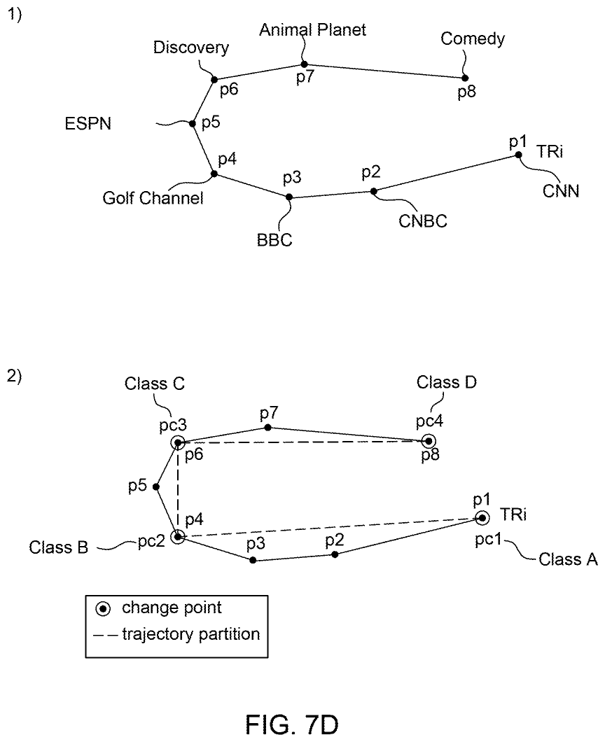

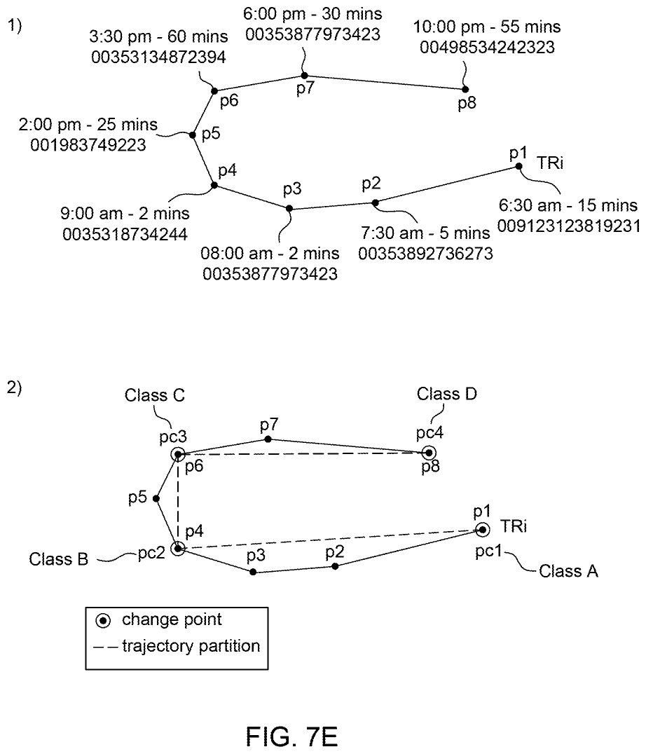

For example, FIG. 7A illustrates a partitioning example of economic transactions. Specifically, FIG. 7A (ii) shows points Pc1, Pc2, Pc3, and Pc4 as partitioning points of the trajectory shown in FIG. 7A (i). In the illustrated example, P1 is determined to be a partitioning point because as shown in FIG. 7A (i) the user first made a purchase from Aldi (P1) which is classified as ‘discount groceries’ and then made a purchase from Lidl (P2) which is also classified as ‘discount groceries’. Similarly, Pc2 is a partitioning point because the user made a purchase from Sports Experts (P4) which is classified as ‘sports & outdoor retailer’. Likewise, Pc3 illustrates a partitioning point marked by a purchase from Starbucks (P6), which is classified as ‘chain restaurant’. Finally, Pc4 is a partitioning point based on the purchase from books.com (P8), which is classified as ‘on-line books and media retailer’.

Although FIG. 7A illustrates determining partitioning points based on classification of the merchant, other criteria may be used. For example, the partitioning may be based on the geolocation of the transaction, whether the transaction was performed online and the currency used in the transaction.

FIG. 7B illustrates a partitioning example of a healthcare transaction. Specifically, FIG. 7B shows the sequence of service codes with the dates. In some instances, the service codes are CPT (Current Procedural Terminology) codes. For example, codes 99234-99236 are used for a same-date admission and discharge in the observation status or inpatient setting. J2930 is a code for Injection, methylprednisolone sodium succinate, up to 125 mg. 36641 is likely DIABETIC CATARACT diagnosis code, while 99070 is a code for Supplies and materials (except spectacles), provided by the physician or other qualified health care professional over and above those usually included with the office visit or other services rendered (list drugs, trays, supplies, or materials provided). Combined with the dates, the trajectory can be partitioned with the service codes.

Although FIG. 7B illustrates an example of partitioning based pn the service code and date that the treatment was received, other criteria may be used. For example, the partitioning may be based on the geolocation of the treatment provider, the type of payment/insurance used or the particular service provider rendering the service.

Next, FIG. 7C a partitioning example of utility usage patterns. Specifically, FIG. 7C shows a daily energy usage of a household, starting from 7:15 am, e.g. early morning peak usage (heating/cooking), till 9:30 am, and an off-peak usage till 4:00 pm, which may involve TV viewing and lighting etc., and another peak usage again. In this example. the partitioning is done based on the value of the usage and the timestamps. However, in other instances the partitioning may be done based on geolocation of the utility consumption or the weather at the geolocation.

Although FIG. 7D illustrates partitioning based on the classification of the television network, the partitioning may also be made based on the type of media (e.g., broadcast, on demand, streaming, etc.) or the time that the media is consumed. In some instances, the partitioning may be made based on a classification of the type of program watched (e.g., Football Match, Comedy, News Analysis etc.).

FIG. 7E shows an example of a partitioning example for telecom usage patterns. For example, FIG. 7E (i) shows a trajectory P1-P8 for list of phone calls (call time) made by one subscriber across different time periods of a call. It starts with an early international call (P1), possibly a family call, with reasonable durations (16 mins) on 6:30 am. It is followed by two local short-duration calls to Irish mobiles (P2-P3), and another short-duration call to a local Irish number (P4). During daytime, longer phone calls with local Irish numbers (P5-P6). During evening time, more phone calls to Irish mobile numbers (P7) and international numbers (P8). Based on the call time, call duration and the region, the sequence is partitioned into partitions Pc1-Pc5 as illustrated in FIG. 7E (ii).

In other instances, the partitioning may be performed based on any combination of call time, call duration and region (as indicated by dialing codes etc.). In some instances, the partitioning may be performed based on an inferred intent of the call (e.g. business call, ordering food, family etc). The inferred intent may be determined based on the number dialed and the time of day.

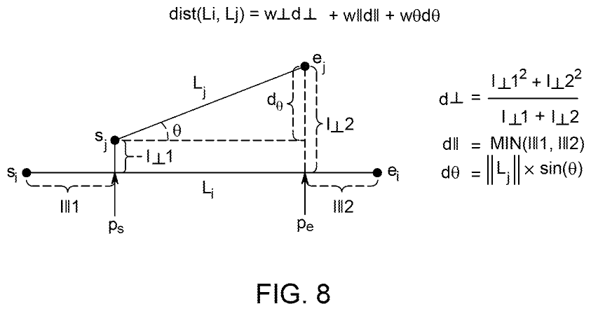

FIG. 8 illustrates an example method to determine the similarity between trajectory partitions. In process 540, the partitioned trajectory partitions are grouped based on their similarities. In the context of transaction trajectories, the similarity between trajectory partitions may be defined as closeness between partitions. However, the similarity, or the distance, between partitions should be defined based on particular scenarios. For example, the similarity of the medical service codes is calculated based on the nature of the treatments, instead of the value of the codes. The similarity of energy usage is then based on the number of kwh, e.g. the values. There is no unified definition across all scenarios.

An example implementation of process 540 is density-based clustering, e.g., grouping partitions based on their session sequence similarity measures between each other. In an example, density-based clustering method, the similarity between two partitions is calculated based on weighted sum of the dimensions in FIG. 8.

In order to obtain optimal sequence matches, the session sequences may be shifted left or right to align as many transactions as possible.

In some instances, process 540 may utilize density-based clustering algorithms (i.e., DBSCAN) to find the similar partitions. Trajectory partitions that are close (e.g., similar) are grouped into the same cluster.

The parameters used in this similarity analysis may be determined either manually or automatically by applying statistical analysis on all trajectories. For example, DBSCAN requires two parameters, E and minPts, the minimum number of partitions required to form a dense region. K-nearest neighbor may be applied to the datasets to estimate the value of E, after minPts is chosen.

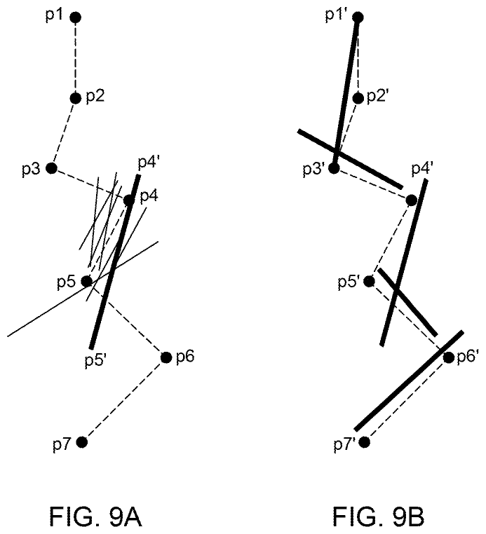

The results of the exchanging process 550 are illustrated in FIG. 9A and FIG. 9B. The purpose of the exchanging process 550 is to selectively shuffle partitions of multiple different trajectories based on the similarity partitions identified in process 540. For example, FIG. 9A shows the partitions p4 p5 has multiple similar partitions from other trajectories. To maximize the difference between the exchanged partitions and hence the anonymization effects, the partitions with the maximum distance from a particular partition is chosen as the swap target (p4′p5′ in the figure).

During the exchanging process 550, the partitions are paired with the selected partitions, and exchanged between trajectories. Therefore, no partitions are dropped. If a partition is not in any of the clusters, the partition is left untouched.

After all partitions are exchanged, the trajectory is transformed into a set of disjoined or touching partitions as FIG. 9B. These segments are then re-assembled into the anonymized trajectory. As an example of the implementation, the following rules are used to assemble the partitions back into a trajectory:
If a partition is crossed with another segment, the cross points are used as the anonymized trajectory point;
If a partition is disjoined with another partition, a new partition is added to connect two partitions.

In another implementation the partitions can be joined by moving the respective end-points of the parts together.

The secure anonymized data may then be generated from the anonymized trajectory without the secure anonymized data being able to be associated with a particular user.

Although features and elements are described above in particular combinations, one of ordinary skill in the art will appreciate that each feature or element may be used alone or in any combination with the other features and elements. In addition, a person skilled in the art would appreciate that specific steps may be reordered or omitted.

Furthermore, the methods described herein may be implemented in a computer program, software, or firmware incorporated in a computer-readable medium for execution by a computer or processor. Examples of computer-readable media include electronic signals (transmitted over wired or wireless connections) and non-transitory computer-readable storage media. Examples of non-transitory computer-readable storage media include, but are not limited to, a read-only memory (ROM), a random access memory (RAM), a register, cache memory, semiconductor memory devices, magnetic media, such as internal hard disks and removable disks, magneto-optical media, and optical media such as CD-ROM disks, and digital versatile disks (DVDs).

What is claimed is:

1. A system for improving security of personally identifiable information stored in an anonymized database, the system comprising:
a first communication interface that is communicatively coupled to a User Identifiable Database, wherein the User Identifiable Database stores a plurality of purchase records and time records that are associate with unique individuals;
a second communication interface that is communicatively coupled to the anonymized database;
a memory; and
a processor that is communicatively coupled to the first communication interface, the second communication interface and the memory;
wherein the processor is configured to:
receive, using the first communication interface, the plurality of purchase records and time records from the User Identifiable Database,
determine transaction trajectories for each of the unique individuals based on the plurality of purchase records and time records received,
partition each of the transaction trajectories into a plurality of partitions,
identify similar trajectories in the plurality of partitions,
generate anonymized trajectories by exchanging the similar trajectories identified, and
store, using the second communication, anonymized location and time records in the anonymized database based on the anonymized trajectories generated.

2. The system according to claim 1, wherein the processor is configured to partition each of the transaction trajectories into the plurality of partitions based a particular time when a particular user made a particular purchase.

3. The system according to claim 1, wherein the processor is configured to partition each of the transaction trajectories into the plurality of partitions based on a classification of each of merchant that performed respective transactions.

4. The system according to claim 3, wherein the processor is configured to partition each of the transaction trajectories into the plurality of partitions by a change in classification of merchants of successive transactions in respective transaction trajectories

5. The system according to claim 1, wherein the plurality of purchase records and time records are collected by a financial institution.

6. The system according to claim 1, wherein the processor is configured to identify the similarities in the trajectories in the plurality of partitions based on a density-based clustering algorithm.

7. The system according to claim 1, wherein the processor is configured to identify the similarities in the trajectories in the plurality of partitions based on a weighted sum of a perpendicular distance (d_{⊥}), a parallel distance (d_{∥}), and angle distance (d_{θ}) between the plurality of partitions.

8. A method for improving security of personally identifiable information stored in an anonymized database, the method comprising:
receiving, by a processor, a plurality of purchase records and time records from a User Identifiable Database, wherein the User Identifiable Database stores the plurality of purchase records and time records that are associate with unique individuals;
determining, by the processor, transaction trajectories for each of the unique individuals based on the plurality of purchase records and time records received;
partitioning, by the processor, each of the transaction trajectories into a plurality of partitions;
identifying, by the processor, similar trajectories in the plurality of partitions;
generating, by the processor, anonymized trajectories by exchanging the similar trajectories identified; and
storing, by the processor, anonymized location and time records in the anonymized database based on the anonymized trajectories generated.

9. The method according to claim 8, wherein each of the transaction trajectories are partitioned into the plurality of partitions based a particular time when a particular user made a particular purchase.

10. The method according to claim 8, wherein each of the transaction trajectories are partitioned into the plurality of partitions based on a classification of each of merchant that performed respective transactions.

11. The method according to claim 8, wherein each of the transaction trajectories are partitioned into the plurality of partitions based on a change in classification of merchants of successive transactions in respective transaction trajectories

12. The method according to claim 8, wherein the plurality of purchase records and time records are collected by a financial institution.

13. The method according to claim 8, wherein the similarities in the trajectories in the plurality of partitions are identified based on a density-based clustering algorithm.

14. The method according to claim 8, wherein the processor is configured to identify the similarities in the trajectories in the plurality of partitions based on a weighted sum of a perpendicular distance (d_{⊥}), a parallel distance (d_{∥}), and angle distance (d_{θ}) between the plurality of partitions.

15. A non-transitory computer readable storage medium that stores instructions that when executed by a processor cause the processor to:
receive, using a first communication interface, a plurality of purchase records and time records from a User Identifiable Database, wherein the User Identifiable Database stores the plurality of purchase records and time records that are associate with unique individuals;
determine transaction trajectories for each of the unique individuals based on the plurality of purchase records and time records received,
partition each of the transaction trajectories into a plurality of partitions,
identify similar trajectories in the plurality of partitions,
generate anonymized trajectories by exchanging the similar trajectories identified, and
store, using a second communication, anonymized location and time records in an anonymized database based on the anonymized trajectories generated.

16. The non-transitory computer readable storage medium according to claim 15, wherein each of the transaction trajectories are partitioned into the plurality of partitions based a particular time when a particular user made a particular purchase.

17. The non-transitory computer readable storage medium according to claim 15, wherein each of the transaction trajectories are partitioned into the plurality of partitions based on a classification of each of merchant that performed respective transactions.

18. The non-transitory computer readable storage medium according to claim 15, wherein each of the transaction trajectories are partitioned into the plurality of partitions based on a change in classification of merchants of successive transactions in respective transaction trajectories

19. The non-transitory computer readable storage medium according to claim 15, wherein the plurality of purchase records and time records are collected by a financial institution.

20. The non-transitory computer readable storage medium according to claim 15, wherein the similarities in the trajectories in the plurality of partitions are identified based on at least one of a density-based clustering algorithm, a weighted sum of a perpendicular distance (d_{⊥}), a parallel distance (d_{∥}), and angle distance (d_{θ}) between the plurality of partitions.
